(19) United States
(12) Patent Application Publication
(10) Pub. No.: US 2005/0220525 A1
(43) Pub. Date: Oct. 6, 2005

(54) Print carrying device

(75) Inventor: Akimasa Kaya, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/091,338

(22) Filed: Mar. 29, 2005

(30) Foreign Application Priority Data
Mar. 29, 2004 (JP) 2004-096906

(51) Int. Cl. B41J 13/076; B41J 13/10

(52) U.S. Cl. 400/634; 400/646; 400/636; 400/642; 400/641

(57) ABSTRACT

A print carrying device comprises a first stage and a second stage. The first stage receives a print discharged by a discharge roller pair in a discharging direction (first direction). The second stage carries the print in a second direction different from the discharging direction. The first stage includes a pushing mechanism, which pushes the print in the second direction to press an end of the print against a carrying roller pair disposed in the second stage. Te pushing mechanism comprises a pushing unit provided with claws, and a driving unit for pulling the pushing unit.

### BACKGROUND OF THE INVENTION

1. Field of the Invention

The present invention relates to a print carrying device for carrying a print, which has been discharged from a printer in a first direction, in a second direction different from the first direction.

2. Description of the Related Art

A print carrying device for carrying a print, which has been discharged from a printer, is known (see Japanese Patent Laid-Open Publication No. 8-174941, for instance). Such a print carrying device carries the discharged print toward a back-printing unit and a sorter in which post-processing of back-printing and sorting is performed for the print on which an image has been recorded in the printer.

It is required that the discharged print is fed to the back-printing unit and the sorter in a proper position. Thus, it is preferable to carry the discharged print without changing its course by placing the back-printing unit and the sorter in a discharging direction of the print. By doing so, the discharging direction coincides with a carrying direction so that a structure of the print carrying device becomes simple.

In this case, however, the printer must be placed in series with the back-printing unit and the sorter. Consequently, a size of the entire printing apparatus is likely to be enlarged. In consideration of this, the print carrying device described in the above-noted Publication No. 8-174941 is provided with a mechanism for sucking and carrying a print to turn an advancing direction of the discharged print in a comparatively free manner. In virtue of this mechanism, the back-printing unit and the sorter are freely placed to some extent so that it is possible to reduce a size of the entire printing apparatus.

However, although the above-mentioned sucking and carrying mechanism has a high degree of freedom for turning the carrying direction, there arises a problem in that a structure thereof becomes complicated.

### SUMMARY OF THE INVENTION

In view of the foregoing, it is a primary object of the present invention to provide a print carrying device in which it is possible to turn a carrying direction of a discharged print by a simple structure.

In order to achieve the above and other objects, the print carrying device according to the present invention comprises a first stage, a carrying roller and a pushing mechanism. The first stage receives a print discharged from a discharge port of a printer, by which an image is recorded on a paper. The print is discharged by a discharge roller in a first direction. The carrying roller carries the print in a second direction different from the first direction. The pushing mechanism presses the print, which is placed on the first stage, against the carrying roller.

In a preferred embodiment, the second direction is perpendicular to the first direction.

It is preferable to provide a feed roller for further feeding the print, which has been discharged by the discharge roller, in the first direction. The feed roller separates a posterior end of the print from the discharge roller.

The pushing mechanism comprises a pushing unit and a driving unit. The pushing unit abuts on an end of the print discharged onto the first stage to push it in the second direction. The driving unit pulls the pushing unit in the second direction. It is preferable that the driving unit and the pushing unit are coupled by a spring.

It is preferable that a back-print head is disposed in a second stage in which the carrying roller is disposed. The back-print head performs printing on a rear surface of the print while the print is carried in the second direction.

According to the present invention, it is possible to turn the carrying direction of the discharged print by a simple structure.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a perspective view of a printing apparatus;

FIG. 2 is an exploded perspective view showing a print carrier;

FIG. 3A and 3B are top views partially showing the print carrier;

FIGS. 4A, 4B and 4C are explanatory illustrations showing a feed roller pair;

FIGS. 5A and 5B are explanatory illustrations of a paper guide; and

FIG. 6 is a flowchart showing a carrying procedure of a discharged print.

### DETAILED DESCRIPTION OF THE PREFERRED EMBODIMENT(S)

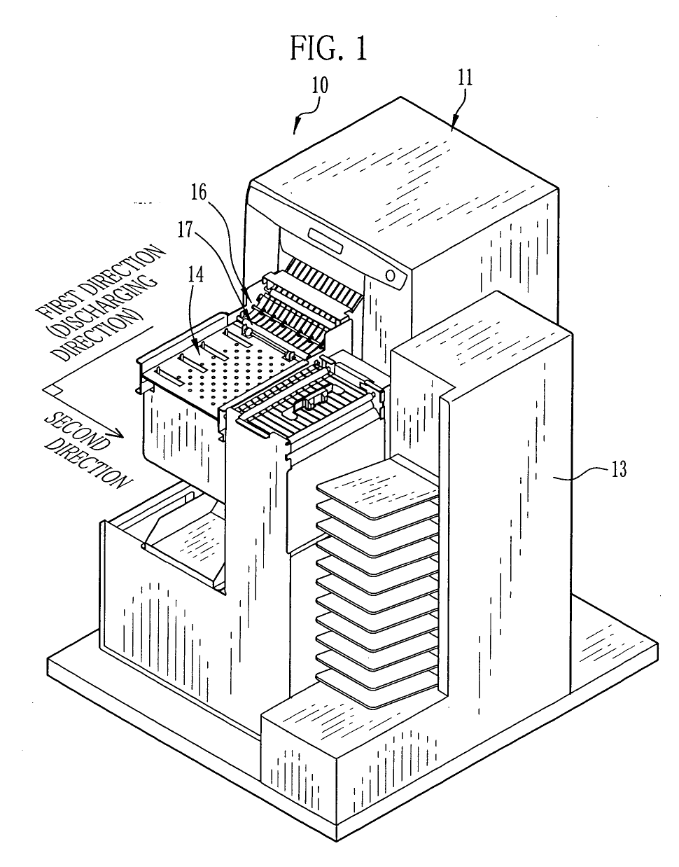

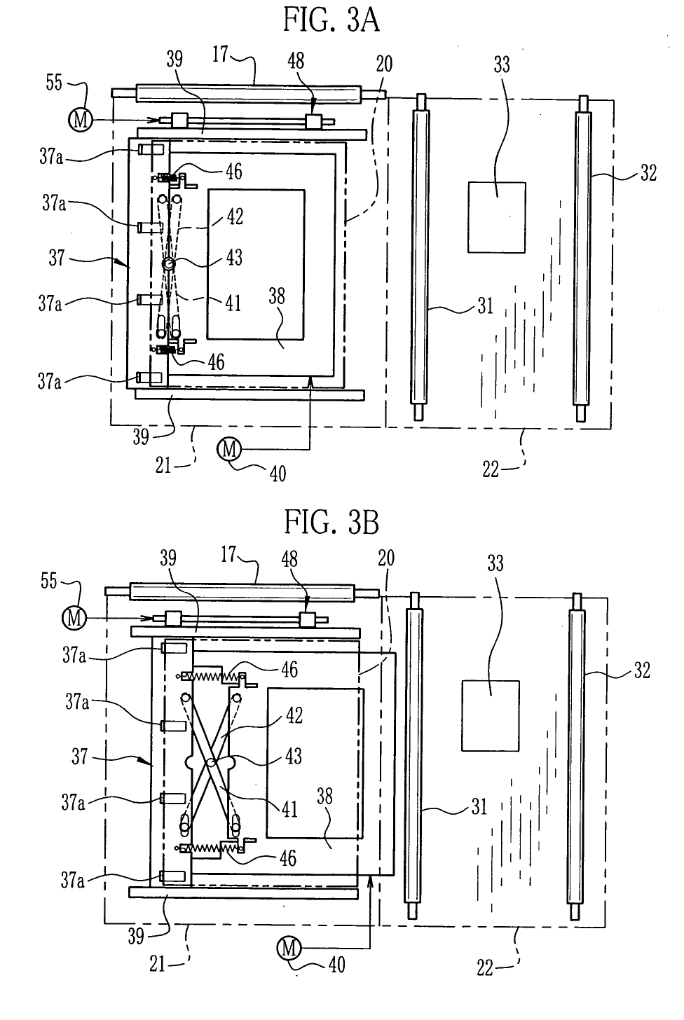

A printing apparatus 10 shown in FIG. 1 includes a main unit 11 for recording an image on a paper, a sorter 13 for sorting a print (denoted by reference numeral 20 in FIGS. 3A and 3B) discharged from the main unit 11, and a print carrier 14 for carrying the print 20 from the main body 11 to the sorter 13. The front of the main unit 11 is provided with a discharger 16 for discharging the print 20. The print carrier 14 turns a carrying direction of the print 20, which has been discharged from the discharger 16, from a discharging direction (first direction) to a second direction perpendicular to the discharging direction. The print carrier 14 forwards the print to the sorter 13 disposed at a lateral side of the main unit 11. In this way, the print carrier 14 turns the carrying direction of the print 20 so that it becomes possible to dispose the sorter 13 at the lateral side of the main unit 11, for example. That is, a degree of freedom for placing the sorter 13 raises. Accordingly, it is possible to make the entire size of the printing apparatus 10 compact.

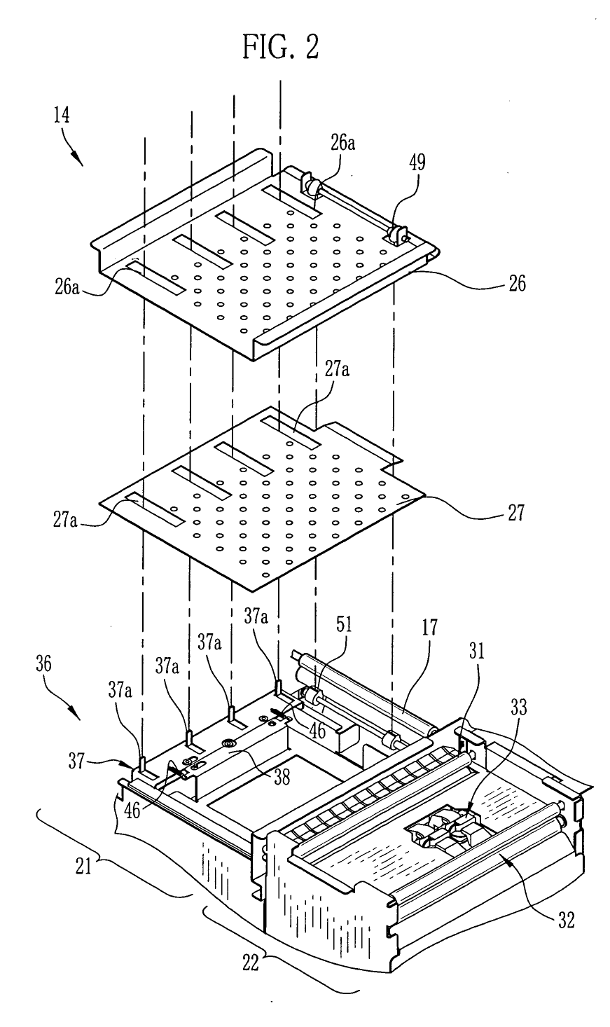

As shown in FIGS. 2 and 3, the print carrier 14 is disposed in front of a discharge roller pair 17 attached to the discharger 16, namely at a downstream side of the discharge roller pair 17 in the discharging direction (first direction). The print carrier 14 comprises a first stage 21 and a second stage 22. The first stage 21 receives the print 20 just discharged from the discharge roller pair 17. The print 20 discharged onto the first stage 21 is carried by the second stage 22 in the second direction, and is fed into the sorter 13.

The first stage 21 is provided with a pair of paper guides 26 and 27 vertically arranged. The print 20 is fed from the discharge roller pair 17 into a gap formed between the paper guides 26 and 27. The print 20 placed on the first stage 21 is carried in the lateral direction (second direction) without changing its position. In other words, the print 20 fed onto the first stage 21 is carried in the second direction in a state that an anterior end of the print 20 in the discharging direction is not turned to the second direction. That means, the print 20 is carried in the second direction in a state that a lateral end of the print 20 in the discharging direction is as an anterior end thereof in the second direction.

The second stage 22 is provided with a first carrying roller pair 31 and a second carrying roller pair 32 as carrying members. The first carrying roller pair 31 is positioned at a former part of the second stage 22, and the second carrying roller pair 32 is positioned at a downstream side of the first carrying roller pair 31. Between the carrying roller pairs 31 and 32, a back-print head 33 is disposed. The back-print head 33 performs printing on a rear surface of the print 20 while the print 20 is carried toward the sorter 13. For example, the back-print head 33 is a print head of an ink-jet system in which an ink is jetted to perform printing.

The first stage 21 includes a pushing mechanism 36, which pushes the print 20 toward the first carrying roller pair 31 to press the anterior end of the print 20 in the second direction against the first carrying roller pair 31. The pushing mechanism 36 comprises a pushing unit 37 and a driving unit 38. The pushing unit 37 pushes the print 20 in the second direction by four claws 37a. The claw 37a abuts on a posterior end of the print 20 in the second direction. The claws 37a are formed on a base of the pushing mechanism 36 and are arranged in a perpendicular direction to the second direction. The driving unit 38 pulls and moves the pushing unit 37 in the second direction. The pushing unit 37 and the driving unit 38 are retained by guide rails 39 so as to be movable in the second direction.

In the initial state of the pushing unit 37 shown in FIG. 3A, the claw 37a is kept in an evacuation position evacuating from a passage of the print 20 to be fed onto the first stage 17 by the discharge roller pair 17. After the print 20 has been fed to the first stage 17, the pushing unit 37 is moved toward the first carrying roller pair 31 to push the print 20, such as shown in FIG. 3B.

The pushing unit 37 is indirectly driven by a first drive motor 40 via the driving unit 38. If a driving forth of the first drive motor 40 is directly transmitted to the pushing unit 37, the force is too strong so that it is likely to damage the edge of the print 20 by the claw 37a abutting thereon. In view of this, the pushing unit 37 for abutting on the print 20 is divided from the driving unit 38 to which the driving force of the first drive motor 40 is directly transmitted. By interlocking the pushing unit 37 and the driving unit 38 with a spring 46, the driving force of the first drive motor 40 is adapted to be transmitted to the print 20 in a buffered state. The spring 46 is expanded against its urging forth upon movement of the driving unit 38, and in association with this, the spring 46 accumulates a restoring force. When the restoring force has reached a predetermined level, the pushing unit 37 is pulled.

The pushing unit 37 and the driving unit 38 are coupled by a pair of coupling members 41 and 42. The pair of the coupling members 41 and 42 intersect with each other at central portions thereof so as to be rotatable around a shaft 43 attached to the intersection of the coupling members 41 and 42. One end of each of the coupling members 41 and 42 is attached to the pushing unit 37 and the other end thereof is attached to the driving unit 38. The respective coupling members 41 and 42 rotate around its central portion in association with the movement of the driving unit 38, and the pushing unit 37 is moved in parallel with the driving unit 38.

In the initial state shown in FIG. 3A, the pushing unit 37 comes into contact with the driving unit 38 without a gap. Upon starting the movement of the driving unit 38 toward the first carrying roller pair 31, the pair of the coupling members 41 and 42 are rotated so that the gap of the pushing member 37 and the driving member 38 gradually increases. In association with this, the spring 46 is expanded. When the restoring force of the spring 46 has reached the predetermined level, the pushing unit 37 is moved in the second direction such as shown in FIG. 3B. By this movement, the claw 37a pushes the print 20 in the second direction to press the anterior end thereof against the first carrying roller pair 31.

The first carrying roller pair 31 is halted while the print 20 is pushed by the pushing unit 37. After the anterior end of the print 20 has been pressed against the first carrying roller pair 31 in parallel, the first carrying roller pair 31 commences rotating. In virtue of this, when the print 20 is pushed in an improper condition, it is prevented that the first carrying roller pair 31 commences to carry the print 20 in this improper condition.

If the posterior end of the print 20 in the discharging direction comes into contact with the discharge roller pair 17 at the time of carrying the print 20 in the second direction, the print 20 is likely to be obliquely carried as the print 20 is dragged due to friction with the discharge roller pair 17. In consideration of this, the first stage 21 is provided with a feed roller pair 48 disposed near the discharge roller pair 17. The feed roller pair 48 feeds the print 20 toward the center of the first stage 21, and separates the posterior end of the print 20 in the discharging direction from the discharge roller pair 17.

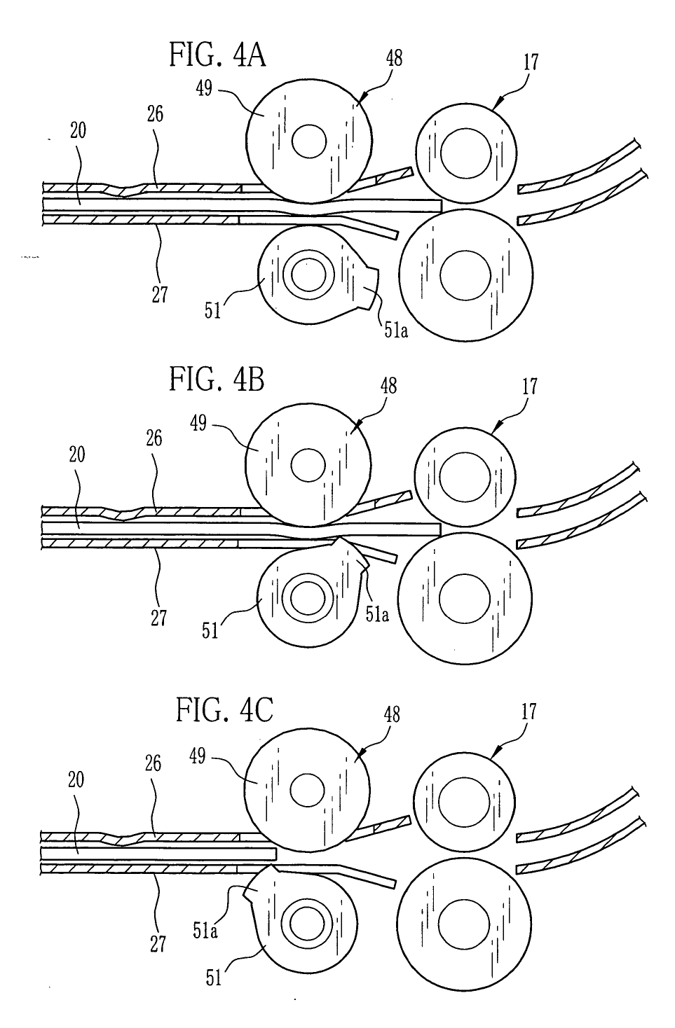

As shown in FIG. 4, the feed roller pair 48 comprises an upper roller 49 and a lower roller 51. The roller 51 is a deformed roller having a section of an eggplant-like shape. As to the roller 51, lengths from the rotational center are not constant regarding entire circumference. The roller 51 is disposed such that only a protrusion 51a enters a passage of the print 20 to come into contact with the rear surface of the print 20.

As shown in FIG. 4A, the protrusion 51a is evacuated from the passage of the print 20 while the print 20 is discharged by the discharge roller pair 17. After the discharge roller pair 17 has discharged the print 20, the feed roller pair 48 commences rotating. Thereupon, the roller 51 rotates in a counterclockwise direction in the drawing, and the protrusion 51a enters the passage to come into contact with the rear surface of the print, such as shown in FIG. 4B. Successively, the roller 51 rotates to sink the protrusion 51a into the print 20. The protrusion 51a cooperates with the roller 49 to feed the print 20 toward the center of the first stage 21. Thus, such as shown in FIG. 4C, the posterior end of the print 20 is completely separated from the discharge roller pair 17. The roller 51 is further rotated to evacuate the protrusion 51a from the passage. Consequently, a feed amount of the print 20 is limited to a prescribed amount. The feed roller pair 48 is driven by a second drive motor 55 of which drive timing is controlled by a controller not shown.

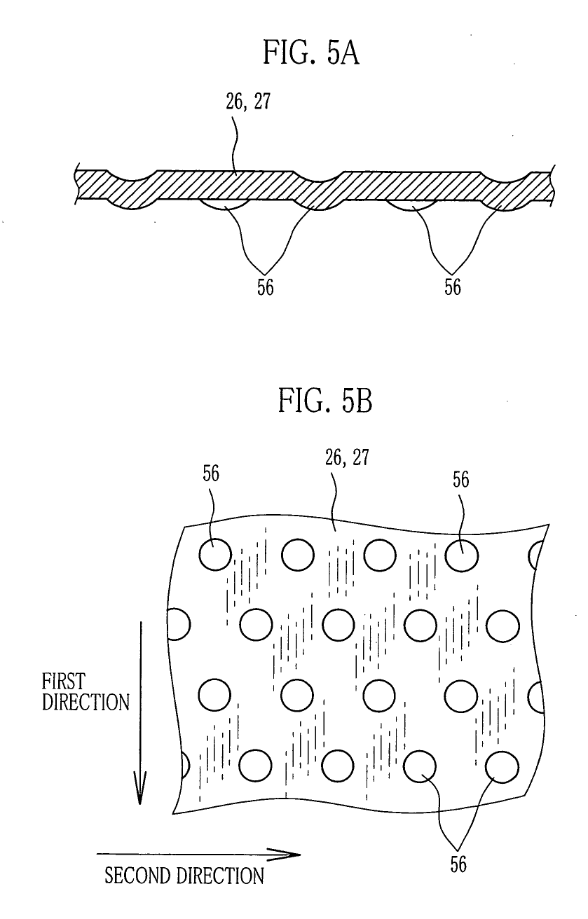

Meanwhile, the respective paper guides 26 and 27 are formed with slits 26a and 27a through which the claws 37a pass and by which movement passages of the claws 37a are secured. Further, such as shown in FIG. 5, the respective paper guides 26 and 27 have a plurality of projections 56, which are formed on a surface confronting the print 20 in order to reduce friction of the print 20 and the respective paper guides 26 and 27.

If the carrying direction is one-way, it is ideal that ribs are formed so as to be parallel in the carrying direction. However, the print 20 is carried in the gap of the respective paper guides 26 and 27 in the first and second directions. If the ribs are formed in one direction, the rib becomes an impediment in the other direction. In view of this, the projections 56 are arranged so as to deal with the plural directions. Regarding an arrangement of the projections 56, a zigzag arrangement is preferable. Concretely, it is preferable that the projections 56 of the respective rows are staggered from the projections 56 of the adjacent row.

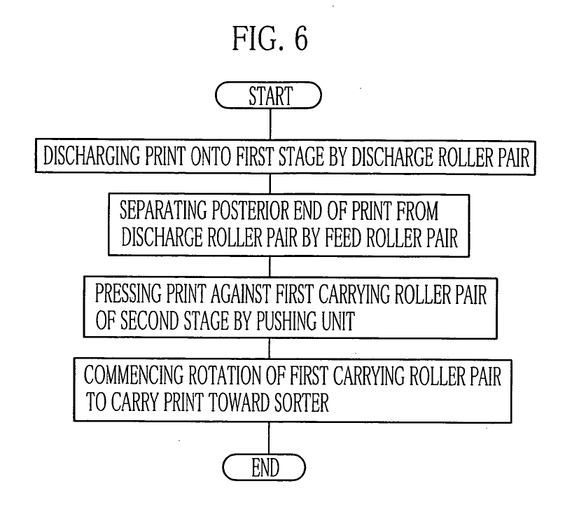

An operation of the above structure is described below, referring to a flowchart shown in FIG. 6. The print 20 on which an image is recorded in the main unit 11 is discharged to the first stage 21 by the discharge roller pair 17. After the discharge roller pair 17 has finished the discharge, the feed roller pair 48 commences rotating. The print 20 is fed in the discharging direction, and the posterior end thereof is separated from the discharge roller pair 17.

Successively, the driving unit 38 commences moving toward the first carrying roller pair 31. The spring 46 is expanded. When the restoring force of the spring 46 has reached the prescribed level, pulling the pushing unit 37 is commenced. The claw 37a abuts on the print 20 to push it toward the first carrying roller pair 31. Since the driving force of the first drive motor 40 is indirectly transmitted to the print 20 via the spring 46, it is prevented to damage the print 20. Moreover, since the print 20 is separated from the discharge roller pair 17 by the feed roller pair 48, oblique movement is prevented from being caused by friction.

After pressing the anterior end of the print 20 against the first carrying roller pair 31, the first carrying roller pair 31 commences rotating to carry the print 20 in the second direction. While the print 20 is pushed, the rotation of the first carrying roller pair 31 is halted. Thus, it is prevented that the print 20 is carried in the second direction, keeping the oblique state. The print 20 nipped by the first carrying roller pair 31 is carried toward the second carrying roller pair 32. During this carry, the back-print head 33 performs printing on the rear surface of the print 20. After printing, the print 20 is forwarded to the sorter 13.

In the above embodiment, the second direction is perpendicular to the first directions. However, these directions may not be perpendicular to each other.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A print carrying device used for a printer by which an image is recorded on a paper, said print carrying device comprising:
a first stage for receiving a print discharged from a discharge port of said printer by a discharge roller in a first direction after recording has been performed by said printer;
a carrying roller for carrying said print in a second direction different from said first direction; and
a pushing mechanism for pressing the print, which is placed on said first stage, against said carrying roller.

2. A print carrying device according to claim 1, wherein said first and second directions are perpendicular to each other.

3. A print carrying device according to claim 1, further comprising:
a feed roller for additionally feeding the print, which has been discharged by said discharge roller, in said first direction, said feed roller separating a posterior end of said print from said discharge roller.

4. A print carrying device according to claim 3, wherein said feed roller is a noncircular roller and a protrusion is formed on a periphery thereof, said print being fed in said first direction by said protrusion.

5. A print carrying device according to claim 4, wherein said feed roller is disposed at an under side of said print.

6. A print carrying device according to claim 1, wherein said pushing mechanism comprises:
a pushing unit for abutting on an end of the print, which has been discharged onto said first stage, to push said print in said second direction;
a driving unit for pulling said pushing unit in said second direction; and
a spring member for coupling said driving unit and said pushing unit, said spring member pressing said print against said carrying roller via said pushing unit.

7. A print carrying device according to claim 6, wherein said pushing unit is provided with a plurality of claws for pushing said print in said second direction.

8. A print carrying device according to claim 1, further comprising:
a second stage in which said carrying roller is disposed; and
a back-print head disposed in said second stage, said back-print head performing printing on a rear surface of said print carried in said second direction.

9. A print carrying device according to claim 1, further comprising:
a pair of guides disposed at said first stage, said guides being vertically disposed and said print being discharged into a gap formed between said guides.

10. A print carrying device according to claim 9, wherein said guide is provided with a plurality of projections formed on a surface thereof confronting said print, said projections supporting said print.

11. A print carrying device according to claim 10, wherein said projections are arranged in a zigzag state.
